(19) United States
(12) Patent Application Publication
(10) Pub. No.: US 2004/0178055 A1
(43) Pub. Date: Sep. 16, 2004

(54) Transfer of electrostatic charge to particles

(76) Inventor: Gerald L. Munson, Madison, CT (US)

Correspondence Address: JOHN H CROZIER, 1934 HUNTINGTON TURNPIKE, TRUMBULL, CT, 06611

(21) Appl. No.: 10/481,659

(22) PCT Filed: Jun. 21, 2002
(86) PCT No.: PCT/US02/20027

Related U.S. Application Data
(60) Provisional application No. 60/300,299, filed on Jun. 22, 2001.

(51) Int. Cl. B01J 19/08; B01J 19/12

(52) U.S. Cl. 204/164; 422/186.04

(57) ABSTRACT

A device (10) for transferring electrostatic charge to particles in a liquid, including: at least one electrode structure (20) having at least one electrode plate, disposed in an electrically nonconductive conduit (24); a barrier structure (40) disposed in the electrically nonconductive conduit (24) and having at least one opening (42) defined therethrough though which the at least one opening at least some of the liquid flows; and a downstream end of the at least one electrode plate extends into and terminates in the at least one opening (42). A method of transferring electrostatic charge to particles in a liquid is also provided.

### TECHNICAL FIELD

The present invention relates to transferring electrostatic charge generally and, more particularly, to a means and method for transferring electrostatic charge to particles in a liquid.

### BACKGROUND ART

Particles in a circulating liquid tend to become electro statically charged. The potential and polarity of that charge is dependent on the material of the particle and the confinement vessel with which the particles must make contact to create this natural electrostatic charging. In some liquids, the artificial manipulation of these natural electrostatic potentials utilizing extreme potentials, on the order of about 75 kilovolts, can create a hazard to personnel or the potential for a predictable and undesirable chemical or electrochemical reaction. As a result, having a means of manipulating or negating these natural charges with a very low potential is essential to safe and predicable operation.

Accordingly, it is a principal object of the present invention to provide a means and method for transferring electrostatic charge to particles in a liquid.

It is a further object of the invention to provide such means and method that can be economically constructed.

Other objects of the present invention, as well as particular features, elements, and advantages thereof will be elucidated in, or be apparent from, the following description and the accompanying drawing figures

### DISCLOSURE OF INVENTION

The present invention achieves the above objects, among others, by providing, in a preferred embodiment, a device for transferring electrostatic charge to particles in a liquid, comprising: at least one electrode structure having at least one electrode plate, disposed in an electrically nonconductive conduit; a barrier structure disposed in said electrically nonconductive conduit and having at least one opening defined therethrough though which said at least one opening at least some of said liquid flows; and a downstream end of said at least one electrode plate ends into and terminates in said at least one opening. A method of transferring electrostatic charge to particles in a liquid is also provided.

### BRIEF DESCRIPTION OF DRAWINGS

Understanding of the present invention and the various aspects thereof will be facilitated by reference to the accompanying drawing figures, provided for purposes of illustration only and not intended to define the scope of the invention, on which:

FIG. 1 is an side elevational cut-away view, of the device of the present invention.

FIG. 2 is an end elevational view of the device.

### BEST MODE FOR CARRYING OUT THE INVENTION

Reference should now be made to the drawing figures on which similar or identical elements are given consistent identifying numerals throughout the various figures thereof, and on which parenthetical references to figure numbers, when used, direct the reader to the view(s) on which the element(s) being described is (are) best seen, although the element(s) may be seen on other figures also.

The present invention presents the potential for applying electrostatic potentials to particles suspended in a moving liquid utilizing very low potentials. The invention uses a barrier structure to accelerate the particulate laden liquid to a high velocity near the apex of the electrode. This combination of flow and charge, with the ability to bring a high percentage of the particulate into physical contact with the electrode during the transition across the apex of the electrode maximizes the charge transfer at extremely low potentials The ability to transfer charge at low potentials has the advantage of making the variation in potential from the most charged to the least charged particle less than with other means. This low potential will have maximum benefit where uniformity of effect is desired.

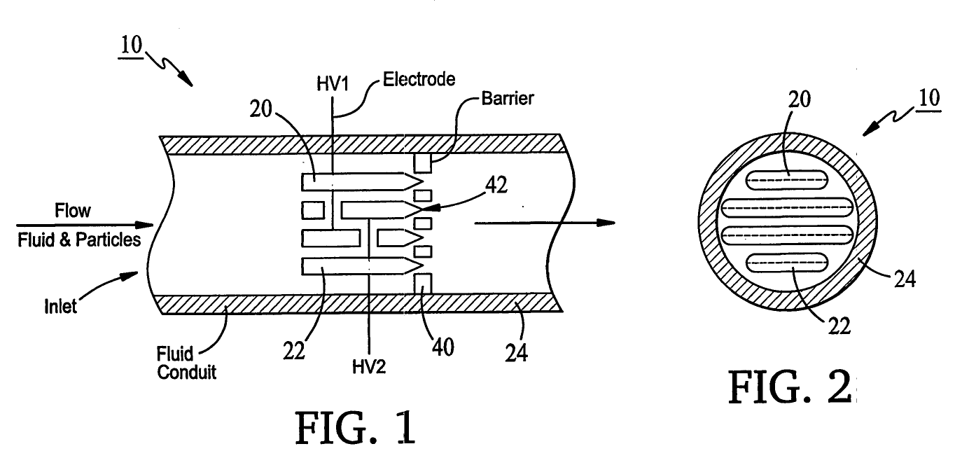

FIGS. 1 and 2 illustrate a charge transfer device, constructed according to the present invention, and generally indicated by the reference numeral 10. Device 10 includes first and second electrode structures 20 and 22, respectively, disposed in an electrically nonconductive liquid conduit 24 and charged positively and negatively, respectively. First and second electrode structures 20 and 22 extend substantially across conduit 24 and each comprises two electrode plates sharpened on their down-stream ends (FIG. 2). One or more than two electrode plates may be provided for each of first and second electrode structures within the contemplation of the present invention, depending on the shape and size of conduit 24. Also, the sides of the electrode plates are shown as being rounded (FIG. 2) but that shape is not critical to the practicing of the present invention. Additionally, a single electrode structure may be employed. First and second electrode structures 20 and 22 may be disposed in separate conduits.

A key element of the present invention is the provision of a barrier structure 40 extending across conduit 24 such that a relatively narrow opening, as at 42 (FIG. 1), is disposed at the apex of each electrode plate. So arranged, the apexes of the electrode plates of first and second electrode structures 20 and 22 extend about halfway into openings 42 (FIG. 1) and are at or close to the highest velocity of the liquid. The voltages on first and second electrode structures range from around five kilovolts to around ten kilovolts and may not be equal.

So arranged, device 10 can charge a large percentage of particulate with minimum electrode potential, adding to safety. In addition, particulate can be charged to a more uniform voltage than can be achieved with straight electrodes and fluid shear is kept to a minimum.

The range of particle sizes and the liquids under consideration may be the same as described in U.S. Pat. No. 5,788,827, issued Aug. 4, 1998, to Gerald L. Munson, and titled MEANS AND METHOD FOR REMOVING PARTICULATE MATTER FROM NONCONDUCTIVE LIQUIDS, the disclosure of which patent is incorporated by reference hereinto. Device 10 may be substitute for charging chamber 42 of purification system 20 shown and described in that patent.

In the embodiments of the present invention described above, it will be recognized that individual elements and/or features thereof are not necessarily limited to a particular embodiment but, where applicable, are interchangeable and can be used in any selected embodiment even though such may not be specifically shown.

Terms such as “above”, “below”, “upper”, “lower”, “inner”, “outer”, “inwardly”, “outwardly”, “vertical”, “horizontal”, and the like, when used herein, refer to the positions of the respective elements shown on the accompanying drawing figures and the present invention is not necessarily limited to such positions.

It will thus be seen that the objects set forth above, among those elucidated in, or made apparent from, the preceding description, are efficiently attained and, since certain changes may be made in the above construction without departing from the scope of the invention, it is intended that all matter contained in the above description or shown on the accompanying drawing figures shall be interpreted as illustrative only and not in a limiting sense.

It is also to be understood that the following claims are intended to cover all of the generic and specific features of the invention herein described and all statements of the scope of the invention which, as a matter of language, might be said to fall therebetween.

1. A device for transferring electrostatic charge to particles in a liquid, comprising:
(a) at least one electrode structure having at least one electrode plate, disposed in an electrically nonconductive conduit;
(b) a barrier structure disposed in said electrically nonconductive conduit and having at least one opening defined therethrough though which said at least one opening at least some of said liquid flows; and
(c) a downstream end of said at least one electrode plate extends into and terminates in said at least one opening.

2. A device for transferring electrostatic charge to particles in a liquid, as defined in claim 1, wherein: said downstream end of said at least one electrode plate is sharpened.

3. A device for transferring electrostatic charge to particles in a liquid, as defined in claim 1, wherein: said at least one electrode structure has a potential of from about five kilovolts to about ten kilovolts.

4. A method of transferring electrostatic charge to particles in a liquid, comprising:
(a) providing at least one electrode structure having at least one electrode plate;
(b) inserting a downstream end of said at least one electrode plate into at least one opening defined through a barrier disposed in an electrically nonconductive conduit through which said liquid flows and through said at least one opening at least some of said liquid flows, such that said downstream end terminates in said at least one opening; and
(c) applying a potential voltage to said at least one electrode structure.

5. A method of transferring electrostatic charge to particles in a liquid, as defined in claim 4, further comprising: providing said downstream end of said electrode plate sharpened.

6. A method of transferring electrostatic charge to particles in a liquid, as defined in claim 4, further comprising: providing said potential voltage in the range of from about five kilovolts to about ten kilovolts.
